(19) United States
(12) Patent Application Publication
(10) Pub. No.: US 2024/0163354 A1
(43) Pub. Date: May 16, 2024

(54) PROGRAM, FRAME TRANSFORMATION DEVICE, AND METHOD

(71) Applicant: RENESAS ELECTRONICS CORPORATION, Tokyo (JP)

(72) Inventors: Yoshiki AZUMA, Tokyo (JP); Takahiro HASHIMOTO, Tokyo (JP)

(21) Appl. No.: 18/480,095

(22) Filed: Oct. 3, 2023

(30) Foreign Application Priority Data
Nov. 16, 2022 (JP) 2022-183213

(51) Int. Cl. H04L 69/18; H04L 69/22

(52) U.S. Cl. CPC H04L 69/18; H04L 69/22

(57) ABSTRACT

By a frame translation device arranged between a first network and a second network which are different in protocols, frames of the first network are sorted, according to their destinations, into first and second buffers according to destinations of the second network, and the frames of the second network, in which one header including the destination is added to the set number of frames collectively outputted from the first and second buffers, are outputted.

### CROSS-REFERENCE TO RELATED APPLICATIONS

The present application claims priority from Japanese Patent Application No. 2022-183213 filed on Nov. 16, 2022, the content of which is hereby incorporated by reference to this application.

### BACKGROUND

The present disclosure relates to a program, a frame translation device, and a method.

There is a disclosed technique listed below. [Patent Document 1] National Publication of Translated Version No. 2019-506094

Patent Document 1 discloses a control unit arranged between a first network based on a first protocol and a second network based on a second protocol. The first network and the second network are a Controller Area Network (CAN) (registered trademark), Ethernet (registered trademark), and the like. The control unit forms a frame, which is based on the second protocol, from a frame based on the first protocol from the first network, and outputs it to the second network.

### SUMMARY

By the way, there is a demand about a reduction in a transmission band of the network.

The inventors have found that the reduction in the transmission band of the network in Patent Document 1 may not be sufficiently considered. In addition, the inventors of the present invention have found that when a plurality of destinations are present, what kind of processing is to be performed in Patent Document 1 may not be sufficiently considered.

Other problems and novel features will become apparent from the description of the present specification and the accompanying drawings.

According to one embodiment, a frame translation device arranged between first and second networks which are different in protocols sorts, according to their destinations, frames of the first network into first and second buffers according to the destinations of the second network, and outputs the frames of the second network, in which one header including the destination is added to the set number of frames collectively outputted from the first and second buffers.

According to one embodiment as mentioned above, it is possible to cope with the case where frames with different destinations coexist and reduce the bandwidth used in the network.

### BRIEF DESCRIPTION OF THE DRAWINGS

FIG. 1 is a diagram showing one example of a system according to a first embodiment.

FIG. 2 is a block diagram showing one example of a frame translation device according to the first embodiment.

FIG. 3 is a diagram showing a specific configuration example of the system according to the first embodiment.

FIG. 4 is a timing chart about frame transmission in the system of the first embodiment.

FIG. 5 is a block diagram showing one example of a frame translation device according to a second embodiment.

FIG. 6 is a block diagram showing one example of a frame translation device according to a first modification example of the second embodiment.

FIG. 7 is a block diagram showing one example of a frame translation device according to a third embodiment.

FIG. 8 is a block diagram showing one example of a frame translation device according to a fourth modification example of the third embodiment.

FIG. 9 is a block diagram showing one example of a frame translation device according to a sixth modification example of the third embodiment.

FIG. 10 is a block diagram showing one example of a frame translation device according to a fourth embodiment.

FIG. 11 is a diagram showing a hardware configuration example of a frame translation device.

### DETAILED DESCRIPTION

Hereinafter, embodiments will be described with reference to the drawings. Incidentally, the same reference numerals are denoted by the same or similar components in the embodiments.

### First Embodiment

### Outline of System

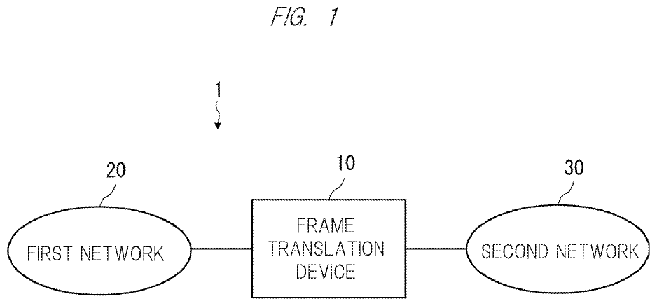

FIG. 1 is a diagram showing one example of a system according to a first embodiment. In FIG. 1, a system 1 has a frame translation device 10, a first network 20, and a second network 30.

The first network 20 is a network based on a first protocol. The second network 30 is a second network based on a second protocol. The first protocol and the second protocol are protocols different from each other. Therefore, format of frames transmitted into the first network 20 is different from format of frames transmitted into the second network 30. For example, although not limited thereto, one of the first network 20 and the second network 30 may be a CAN and the other may be Ethernet.

The frame translation device 10 is arranged between the first network 20 and the second network 30. For example, the frame translation device 10 receives frames, which are based on the first protocol, from the first network 20, and converts the frames based on the first protocol into the frames based on the second protocol. Then, the frame translation device 10 outputs the frames, which are based on the second protocol, to the second network 30.

### Configuration Example of Frame Translation Device

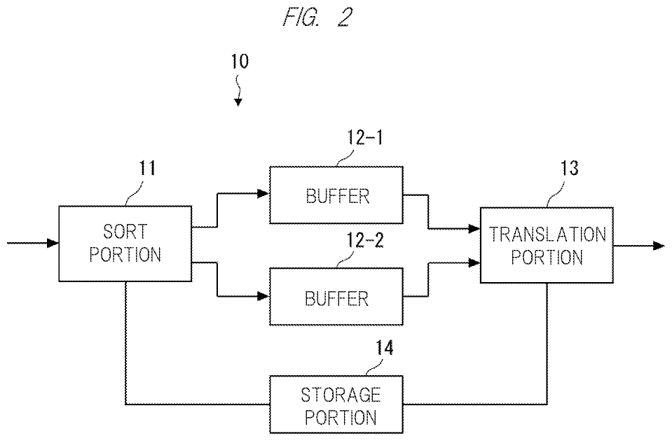

FIG. 2 is a block diagram showing one example of the frame translation device in the first embodiment. In FIG. 2, the frame translation device 10 has a sort portion 11, buffers 12-1, 12-2, a translation portion 13, and a storage portion. The buffers 12-1 and 12-2 are respectively associated with a first destination and a second destination in “destination buffer mapping information (namely, correspondence relationship)”. The “destination buffer mapping information” may be, for example, a destination buffer mapping table. This destination buffer mapping table is stored in the storage portion 14. Further, for example, the first destination is a first processor (not shown) fixedly set up in the second network 30, and the second destination is a second processor (not shown) fixedly set up in the second network 30. Incidentally, in the following description, the buffer 12-1 and the buffer 12-2 may be collectively referred to as buffers 12 when not distinguished from each other. Here, in order to simplify the explanation, the number of buffers 12 included in the frame translation device 10 is assumed to be two, but the number is not limited to this. That is, the number of buffers 12 included in the frame translation device 10 may be three or more. Even in this case, three or more buffers 12 are associated with different destinations.

The sort portion 11 receives the frames based on the first protocol from the first network 20. The frames based on the first protocol include “destination information” in a header part of the frame. Here, the “destination information” indicates the above-mentioned first destination or second destination.

The sort portion 11 sorts the frames, which are based on the first protocol, into the buffers 12 associated with the destination buffer mapping information at the destinations indicated by this destination information of the frames. For example, when the destination information of the frame based on the first protocol indicates the first destination, the sort portion 11 distributes the frame, which is based on the first protocol, into the buffer 12-1 associated with the first destination. Incidentally, the sort portion 11 may directly output the frame based on the first protocol (namely, both header part and payload part), as it is, to the buffer 12 at the time of the sort, or may output a payload part, which excludes the header part out of the frame based on the first protocol, to the buffer 12.

The buffer 12-1 holds the frames sorted by the sort portion 11 (namely, frames whose destination is the first destination). Then, when the number of held frames reaches M, the buffer 12-1 collectively outputs the M frames to the translation portion 13.

The buffer 12-2 holds the frames sorted by the sort portion 11 (namely, frames whose destination is the second destination). Then, when the number of held frames reaches N, the buffer 12-2 collectively outputs the N frames to the translation portion 13.

Here, the above-mentioned values of M and N are each an integer of 1 or more. Further, at least one of the values of M and N is an integer of 2 or more. Then, the value of M may be the same as or different from the value of N. The above-mentioned values of M and N may each be referred to as a “buffer size”.

The translation portion 13 forms a frame based on the second protocol by adding one header based on the second protocol to all of the M frames outputted from the buffer 12-1. That is, the translation portion 13 includes, in the frame based on the second protocol as a payload part of the frame based on the second protocol, all of the M frames outputted from the buffer 12-1 in the frame based on the second protocol. Further, the translation portion 13 forms a frame based on the second protocol by adding one header based on the second protocol including the first destination to the payload part of the frame based on the second protocol.

Similarly, the translation portion 13 forms a frame based on the second protocol by adding one header based on the second protocol to all of the N frames outputted from the buffer 12-2. That is, the translation portion 13 includes, in the frame based on the second protocol as a payload part of the frame based on the second protocol, all of the N frames outputted from the buffer 12-2. Further, the translation portion 13 forms a frame based on the second protocol by adding one header based on the second protocol including the second destination to the payload part of the frame based on the second protocol.

Incidentally, as described above, even when the payload part from which the header part of the frame based on the first protocol is removed is held in the buffer 12, the translation portion 13 refers to the destination buffer mapping information, which makes it possible to specify a destination with which the buffer 12 of an output source of the frame is associated. Therefore, the translation portion 13 can include the “first destination” in the header part of the frame based on the second protocol formed from the M frames outputted from the buffer 12-1. Meanwhile, the translation portion 13 can include the “second destination” in the header part of the frame based on the second protocol formed from the N frames outputted from the buffer 12-2.

Then, the translation portion 13 outputs the formed frame based on the second protocol to the second network 30. This frame based on the second protocol is received by a processor indicating, for example, destination information contained in its header part.

### Operation Example of System

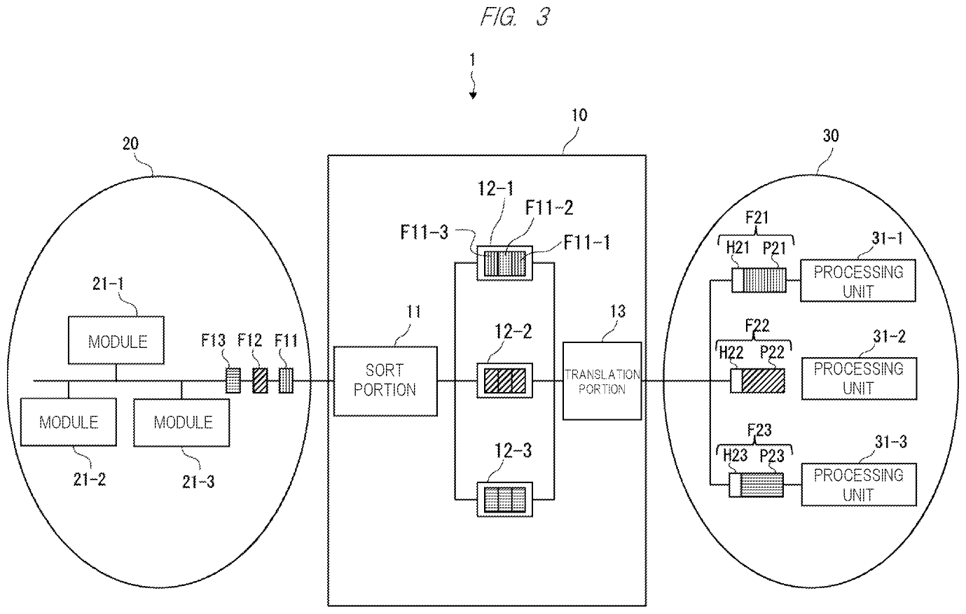

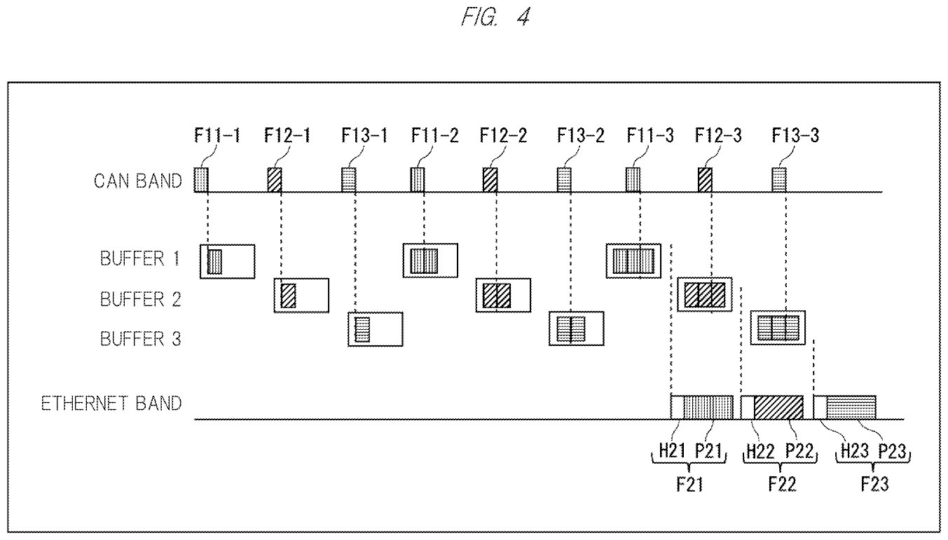

One example of a processing operation of the system 1 having the above-mentioned configuration will be described. FIG. 3 is a diagram showing a specific configuration example of the system according to the first embodiment. FIG. 4 is a timing chart about frame transmission in the system of the first embodiment. Here, one example of a processing operation will be described based on a specific configuration example of the system shown in FIG. 3. Incidentally, in FIG. 3, the storage portion 14 of the frame translation device 10 is omitted.

In FIG. 3, the first network 20 includes processing modules 21-1, 21-2, 21-3. Further, the second network 30 includes processing units 31-1, 31-2, 31-3.

The processing module 21-1 outputs a frame F11 based on the first protocol and addressed to the processing unit 31-1. Further the processing module 21-2 outputs a frame F12 based on the first protocol and addressed to the processing unit 31-2. Furthermore, the processing module 21-3 outputs a frame F13 based on the first protocol and addressed to the processing unit 31-3.

More specifically, as shown in FIG. 4, the processing module 21-1 outputs frames F11-1, F11-2, F11-3. Also, the processing module 21-2 outputs frames F12-1, F12-2, F12-3. Further, the processing module 21-3 outputs frames F13-1, F13-2, F13-3.

Further, as shown in FIG. 3, the frame translation device 10 has a sort portion 11, buffers 12-1, 12-2, 12-3, and a translation portion 13. The buffers 12-1, 12-2, 12-3 are associated with destinations 1, 2, 3, respectively, in the “destination buffer mapping information”. The destinations 1, 2, 3 are associated with the processing units 31-1, 31-2, 31-3, respectively.

The sort portion 11 sorts the frames F11-1, F11-2, F11-3 into the buffer 12-1 corresponding to the destination 1 (namely, processing unit 31-1). Also, the sort portion 11 sorts the frames F12-1, F12-2, F12-3 into the buffer 12-2 corresponding to the destination 2 (namely, processing unit 31-2). Further, the sort portion 11 sorts F13-1, F13-2, F13-3 into the buffer 12-3 corresponding to the destination 3 (namely, processing unit 31-3). In this manner, the sort portion 11 sorts the frames of the first network 20 into the buffers 12 corresponding to the destinations in the second network 30 according to the destinations. This makes it possible to realize the frame translation device 10 adaptable even when the frames with different destinations coexist.

Here, a “buffer size” of each of the buffers 12-1, 12-2, 12-3 is assumed to be a size of the three frames based on the first protocol. That is, when holding three frames based on the first protocol, each of the buffers 12-1, 12-2, 12-3 collectively outputs them to the translation portion 13.

Then, the translation portion 13 forms a frame F21 based on the second protocol and including the header part H21 and the payload part P21. The payload part P21 of the frame F21 based on this second protocol includes the frames F11-1, F11-2, F11-3 collectively outputted from the buffer 12-1. Also, the header part H21 of this frame based on the second protocol includes destination information indicating the processing unit 31-1. Then, the translation portion 13 outputs the formed frame F21 based on the second protocol to the second network 30.

Also, the translation portion 13 forms the frame F22 based on the second protocol and including the header part H22 and the payload part P22. This payload part P22 of eh frame F22 based on the second protocol includes the frames F12-1, F12-2, F12-3 collectively outputted from the buffer 12-2. Also, this header part H22 of the frame based on the second protocol and including destination information indicating the processing unit 31-2. Then, the translation portion 13 outputs the formed frame F22 based on the second protocol to the second network 30.

Also, the translation portion 13 forms the frame F23 based on the second protocol and including the header part H23 and the payload part P23. This payload part P23 of the frame F23 based on the second protocol includes the frames F13-1, F13-2, F13-3 collectively outputted from the buffer 12-3. Further, this header part H23 of the frame based on the second protocol includes destination information indicating the processing unit 31-3. Then, the translation portion 13 outputs the formed frame F23 based on the second protocol to the second network 30.

In this way, the translation portion 13 forms a frame for the second network 30 by adding one header including the destination to the set number of frames collectively outputted from the buffer 12, and outputs this frame to the second network 30. This makes it possible to reduce an overhead due to the header of the frame based on the second protocol in comparison with a case where the header based on the second protocol is formed by adding, to each frame based on the first protocol, the header of the frame based on the second protocol. As a result, a usage band of the second network 30 can be reduced.

### Second Embodiment

A second embodiment relates to adjustment of destination buffer mapping information indicating a correspondence between a buffer and a destination, adjustment of a buffer size, and the like.

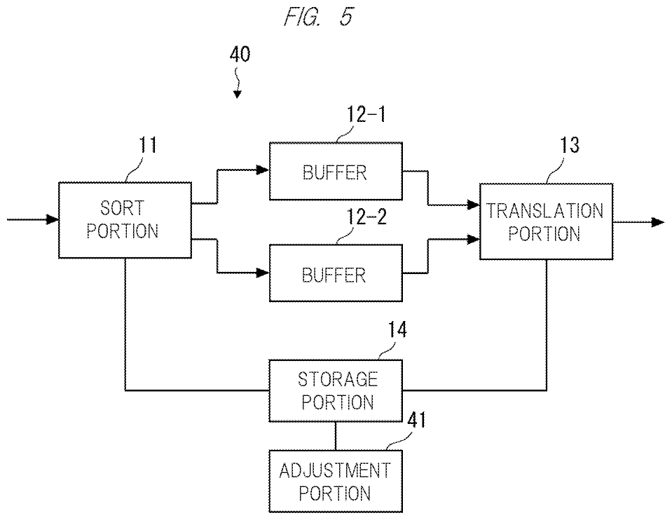

FIG. 5 is a block diagram showing one example of a frame translation device according to a second embodiment. In FIG. 5, a frame translation device 40 has a sort portion 11, buffers 12-1, 12-2, a translation portion 13, a storage portion 14, and an adjustment portion 41. Incidentally, a basic configuration of a system in the second embodiment is the same as that of the system 1 shown in FIG. 1. That is, the system 1 in the second embodiment has a frame translation device 40 instead of the frame translation device 10. Here, in order to simplify the explanation, the number of buffers 12 included in the frame translation device 40 is assumed to be two, but the number is not limited to this. That is, the number of buffers 12 included in the frame translation device 40 may be three or more. Even in this case, three or more buffers 12 are associated with respectively different destinations.

In the second embodiment, the value of M, which is the buffer size of the buffer 12-1, differs from the value of N, which is the buffer size of the buffer 12-2. In the following, the value of M is smaller than the value of N.

The adjustment portion 41 adjusts destination buffer mapping information indicating a correspondence between the buffers 12-1, 12-2 and the first and second destinations. The destination buffer mapping information is stored in the storage portion 14. The adjustment portion 41 adjusts the destination buffer mapping information based on the “priority” of the first destination and the second destination. For example, the adjustment portion 41 adjusts the destination buffer mapping information by referring to “priority information” and “buffer information”. The “Priority information” associates the destination with the priority corresponding to the destination. In other words, the “priority information” associates a processing unit with a priority corresponding to the processing unit. For example, as the processing unit is required to perform a processing more quickly, the priority associated with the processing unit becomes higher. The “Priority information” is, for example, a “priority table”. The “priority table” is stored in the storage portion 14. Also, “buffer information” associates relative priorities with buffers corresponding to the relative priorities. For example, the “buffer information” may associate the buffer 12-1 with a relative priority “high” and the buffer 12-2 with a relative priority “low”. The “buffer information” is, for example, a “buffer table”. The “buffer table” is stored in the storage portion 14.

For example, when the priority of the destination changes depending on timing (for example, time zone), the priority information may include first priority information at first timing and second priority information at second timing. For example, the first priority information for a first time zone specifies that the priority of the first destination is higher than the priority of the second destination. Meanwhile, the second priority information for a second time zone specifies that the priority of the first destination is lower than the priority of the second destination. Then, the adjustment portion 41 refers to the first priority information and the buffer information in the first time zone (namely, first timing) to adjust the destination buffer mapping information so that the first destination with the higher priority is associated with the buffer 12-1 and the second destination with the lower priority is associated with the buffer 12-2. This makes it possible to put weight on, for a destination (processing unit) with a relatively high priority, reducing a delay until the frame reaches the destination (processing unit) rather than reducing a bandwidth used in the second network 30. Also, in the second time zone (namely, second timing after first timing), the adjustment portion 41 refers to the second priority information and the buffer information to adjust the destination buffer mapping information so that the second priority with the higher priority is associated with the buffer 12-1 and the first destination with the lower priority is associated with the buffer 12-2.

The sort portion 11 sorts the frame based on the first protocol to the buffer 12 associated with the destination indicated by the destination information of the frame due to the adjusted destination buffer mapping information. Further, when the payload part from which the header part of the frame based on the first protocol has been removed is held in the buffer 12, the translation portion 13 refers to the adjusted destination buffer mapping information, thereby specifying the destination associated with the buffer 12 of an output source of the frame.

In this way, by adjusting the destination buffer mapping information by the adjustment portion 41, the buffer 12-1 with a small buffer size is caused to hold the frame of destination with a high priority, the delay due to burring of the frame of the destination with a high priority can be reduced. This makes it possible to deliver the frame of the destination with a high priority to the destination more quickly.

Also, the adjustment portion 41 adjusts the destination buffer mapping information at the timing when the frames are not accumulated in the buffers 12-1, 12-2. This makes it possible to avoid accumulating the frames with different destinations in one buffer.

### Modification Example of Second Embodiment

The frame translation device 40 of the second embodiment may be modified as follows.

### First Modification Example

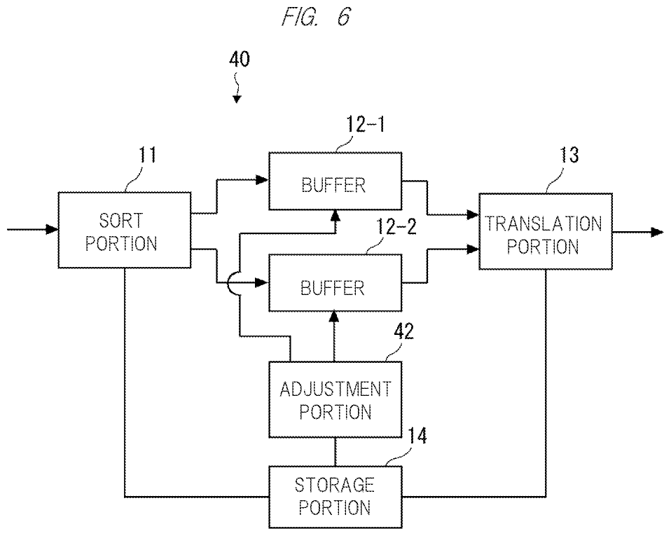

FIG. 6 is a block diagram showing one example of a frame translation device in a first modification example of the second embodiment. In FIG. 6, the frame translation device 40 has a sort portion 11, buffers 12-1, 12-2, a translation portion 13, a storage portion 14, and an adjustment portion.

In a first modification example of the second embodiment, the destination buffer mapping information associates the first destination with the buffer 12-1 and the second destination with the buffer 12-2. That is, in the modification example of the second embodiment, it is assumed that the destination buffer mapping information is fixed.

The adjustment portion 42 adjusts the value of M (namely, buffer size of buffer 12-1) based on the priority of the first destination. Also, the adjustment portion 42 adjusts the value of N (namely, buffer size of buffer 12-2) based on the priority of the second destination. Adjusting the value of M based on the priority of the first destination and adjusting the value of N based on the priority of the second destination may be done independently. In other words, adjustments to the values of M and N may be made based on the absolute priorities of the first and second destinations.

For example, the adjustment portion 42 adjusts the buffer sizes of the buffers 12 by referring to the “priority information”, “buffer size information”, and “destination buffer mapping information”. The “priority information” and “destination buffer mapping information” are the same as those in the second embodiment. The “buffer size information” associates a priority type of a processing unit that can be associated with the processing unit and a buffer size corresponding to the priority type. For example, it is assumed that there are three levels of high, medium, and low levels as priorities. In this case, the “buffer size information” associates buffer sizes 1, 2, and 3 with high, medium, and low levels of the priorities, respectively. The adjustment portion 42 adjusts the value of M according to this “buffer size information” and the priority of the first destination (first processing unit), the value of N may be adjusted according to this “buffer size information” and the priority of the second destination (second processing unit). The “buffer size table” is, for example, a “buffer size table”. The “buffer size table” is stored in the storage portion 14.

For example, it is assumed that the first priority information for the first time zone associates the first processing unit (first destination) with the priority “high” and the second processing unit (second destination) with the priority “low”. In this case, the adjustment portion 42 refers to the first priority information and the buffer size information to specify the buffer size “1” of the first processing unit (first destination). Then, the adjustment portion 42 refers to the “destination buffer mapping information” to specify the buffer 12-1 associated with the first processing unit (first destination) and to adjust the buffer size of this buffer 12-1 to “1”.

With this adjustment by the adjustment portion 42, the higher the priority of the destination, the smaller the buffer size of the buffer corresponding to the destination can be adjusted. This makes it possible to quickly deliver the frames to the destinations with a high priority.

Incidentally, the adjustment portion 42 may adjust the buffer size of the buffer 12 at the timing when no frame is accumulated in the buffer 12. This makes it possible to reliably avoid a loss of the accumulated frame, which can occur by adjusting the value of the buffer size at the timing of accumulating the frame in the buffer 12.

### Second Modification Example

Since a basic configuration of a frame translation device in a second modification example of the second embodiment is the same as that of the frame translation device in the first modification example of the second embodiment, FIG. 6 is referred to.

In the second modification example of the second embodiment, the destination buffer mapping information associates the first destination with the buffer 12-1 and the second destination with the buffer 12-2. That is, in the modification example of the second embodiment, it is assumed that the destination buffer mapping information is fixed.

Based on the priority of the first destination and the priority of the second destination, the adjustment portion 42 of the second modification example of the second embodiment adjusts the value of M (namely, buffer size of buffer 12-1) and the value of N (namely, buffer size of buffer 12-2). That is, the adjustments to the values of M and N may be made based on the relative priorities of the first and second destinations.

For example, the adjustment portion 42 adjusts the buffer sizes of the buffers 12 by referring to the “priority information”, “buffer size information”, and “destination buffer mapping information”. The “priority information” and “destination buffer mapping information” are the same as those in the second embodiment. The “buffer size information” associates the relative priority with the buffer size corresponding to the relative priority. The “buffer size information” associates, for example, the relative priority “high” with the value “1” of the buffer size and the relative priority “low” with the value “3” of the buffer size. The adjustment portion 42 refers to this “buffer size information” and adjusts, to 1, the buffer size of the buffer 12 corresponding to the higher priority out of the first and second destinations. Further, the adjustment portion 42 adjusts, to 3, the buffer size of the buffer 12 corresponding to the lower priority out of the first destination and the second destination. The “buffer size information” is, for example, a “buffer size table”. The “buffer size table” is stored in the storage portion 14.

For example, it is assumed that the first priority information for the first time zone associates the first processing unit (first destination) with the priority “high” and the second processing unit (second destination) with the priority “low”. In this case, the adjusting portion 42 refers to the first priority information and the buffer size information to specify the buffer size “1” of the first processing unit (first destination). Then, the adjustment portion 42 refers to the “destination buffer mapping information” to specify the buffer 12-1 associated with the first processing unit (first destination), and adjusts the buffer size of this buffer 12-1 to “1”.

When the priority of the first destination is higher than the priority of the second destination, the buffer size of the buffer 12-1 holding the frame of the first destination with the higher priority can be made smaller than that of the buffer 12-2 through the adjustment by the adjustment portion 43. This makes it possible to deliver, to the destination, the frame of the first destination with the higher priority earlier than the frame of the second destination.

### Third Embodiment

A third embodiment relates to an embodiment that adjusts the buffer size of the buffer associated with each destination based on a transmission quantity of a frame to each destination.

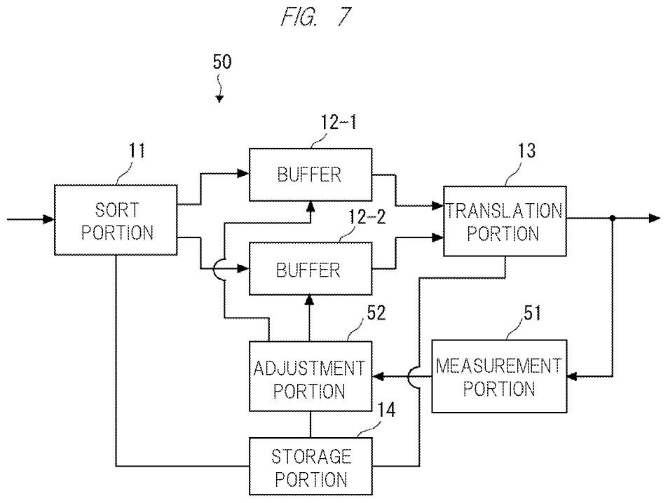

FIG. 7 is a block diagram showing one example of a frame translation device in a third embodiment. In FIG. 7, a frame translation device 50 has a sort portion 11, buffers 12-1, 12-2, a translation portion 13, a storage portion 14, a measurement portion 51, and an adjustment portion 52. Incidentally, a basic configuration of a system in the third embodiment is the same as that of the system 1 shown in FIG. 1. That is, a system 1 in the third embodiment has a frame translation device 50 instead of the frame translation device 10. Here, in order to simplify the explanation, the number of buffers 12 included in the frame translation device 50 is assumed to be two, but the number is not limited to this. That is, the number of buffers 12 included in the frame translation device 50 may be three or more. Even in this case, three or more buffers 12 are associated with respectively different destinations.

In the third embodiment, the destination buffer mapping information associates the first destination with the buffer 12-1 and the second destination with the buffer 12-2. That is, in a modification example of the third embodiment, it is assumed that the destination buffer mapping information is fixed.

The measurement portion 51 measures a transmission quantity of the frames to the first destination based on the second protocol in the second network 30, and a transmission quantity of the frames to the second destination based on the second protocol in the second network 30. Hereinafter, the transmission quantity of the frames to the first destination based on the second protocol in the second network 30 may simply be referred to as a “first transmission quantity”. Also, hereinafter, the transmission quantity of the frames to the second destination based on the second protocol in the second network 30 may simply be referred to as a “second transmission quantity”. The first transmission quantity corresponds to a bandwidth of the second network 30 used by the frames of the first destination, and the second transmission quantity corresponds to a bandwidth of the second network 30 used by the frames of the second destination.

The adjustment portion 52 adjusts the value of M (namely, buffer size of buffer 12-1) based on a first transmission quantity measured by the measurement portion 51. For example, the adjustment portion 52 may adjust the value of M based on the first transmission quantity measured by the measurement portion 51 and the “buffer size information”. The “buffer size information” associates a buffer size with each of a plurality of ranges corresponding to magnitude of the transmission quantity. Specifically, the adjustment portion 52 specifies the buffer size associated with the range corresponding to the first transmission quantity measured by the measurement portion 51 in the “buffer size information”, and may adjust the value of M to this buffer size. The “buffer size information” may associate different buffer sizes (3, 2, 1) with each of three ranges corresponding to the magnitude of the transmission quantity (large, medium, small), for example. The “buffer size information” is, for example, a “buffer size table”. The “buffer size table” is stored in the storage portion 14.

Similarly, the adjustment portion 52 adjusts the value of N (namely, buffer size of buffer 12-2) based on a second transmission quantity measured by the measurement portion 51. For example, the adjustment portion 52 may adjust the value of N based on the second transmission quantity measured by the measurement portion 51 and the “buffer size information”.

Through the adjustment by the adjustment portion 52, the buffer size of the buffer 12 associated with the destination with the large transmission quantity is increased, and the number of frames collectively outputted from the buffer 12 can be increased. Therefore, one header part based on the second protocol is added to many frames outputted from the buffer 12 in the translation portion 13, so that the overhead of the header based on the second protocol can be reduced. This makes it possible to reduce the transmission quantity to the destination in the second network 30, and so to reduce the bandwidth used in the second network 30.

Incidentally, when the first transmission quantity measured by the measurement portion 51 exceeds a first threshold, the adjustment portion 52 increases the value of M (namely, buffer size of buffer 12-1) from the current value to a predetermined value (for example, 1) and may adjust the value of M. The same is true for the value of N. Even in this way, the buffer size of the buffer 12 associated with the destination with the larger transmission quantity than expected is increased, and the number of frames collectively outputted from the buffer 12 can be increased. Therefore, one header part based on the second protocol is added to many frames outputted from the buffer 12 by the translation portion 13, so that the overhead of the header based on the second protocol can be reduced. Consequently, the transmission quantity to the destination in the second network 30 can be reduced, so the bandwidth used in the second network 30 can be reduced.

Further, when the first transmission quantity measured by the measurement portion 51 is less than a second threshold, the adjustment portion 52 decreases the value of M (namely, buffer size of buffer 12-1) from the current value to a predetermined value (for example, 1), and the value of M may be adjusted. The same is true for the value of N. Consequently, the buffer size of the buffer 12 associated with the destination with the smaller transmission quantity than expected can be reduced. This makes it possible to quickly deliver the frame to the destination with the smaller transmission quantity than expected.

Here, the adjustment portion 52 adjusts the buffer size of the buffer 12 at the timing of accumulating no frame in the buffer 12. This makes it possible to reliably avoid the accumulated frame being lost, which can occur if the buffer size value is adjusted at the timing of accumulating the frames in the buffer 12.

### Modification Example of Third Embodiment

The frame translation device 50 of the third embodiment may be modified as follows.

### First Modification Example

A first modification example of the third embodiment corresponds to a mode obtained by combining the third embodiment and the second embodiment. Since a basic configuration of the frame translation device in the first modification example of the third embodiment is the same as that of the frame translation device in the third embodiment, FIG. 7 is referred to. For example, the adjustment portion 52 may set an initial value of M (namely, initial value of buffer size of buffer 12-1) based on the priority of the first destination. Also, the adjustment portion 52 may set an initial value of N (namely, an initial value of buffer size of buffer 12-2) based on the priority of the second destination.

For example, the adjustment portion 52 sets the initial value of the buffer size of the buffer 12 by referring to the “priority information”, “buffer initial size information”, and “destination buffer mapping information”. The “Priority information” and “destination buffer mapping information” are the same as those in the second embodiment. The “buffer initial size information” associates a priority type of a processing unit that can be associated with the processing unit and a buffer initial size corresponding to the priority type. For example, it is assumed that there are three levels of high, medium, and low levels as priorities. In this case, the “buffer initial size information” associates, for example, buffer initial sizes 1, 2, and 3 with high, medium, and low levels of the priorities, respectively. The “buffer initial size information” is, for example, a “buffer initial size table”. The “buffer initial size table” is stored in the storage portion 14.

For example, it is assumed that the priority information associates the first processing unit (first destination) with the “high” priority and the second processing unit (second destination) with the “low” priority. In this case, the adjustment portion 52 refers to the priority information and the initial buffer size information to specify the initial buffer size “1” of the first processing unit (first destination). Then, the adjustment portion 52 refers to the “destination buffer mapping information” to specify the buffer 12-1 associated with the first processing unit (first destination) and to adjust the initial buffer size of this buffer 12-1 to “1”.

Through the adjustment of the initial value of the buffer size by the adjustment portion 52, the higher the priority of the destination, the smaller the initial value of the buffer size of the buffer 12 associated with the destination can be adjusted. This makes it possible to quickly deliver the frames to the destination with the high priority.

Then, if the first transmission quantity measured by the measurement portion 51 exceeds a first threshold, the adjustment portion 52 increases the value of M (namely, buffer size of buffer 12-1) from the current value to a predetermined value (for example, “1”), and may adjust the value of M. The same is true for the value of N.

Further, when the first transmission quantity measured by the measurement portion 51 is less than a second threshold, the adjustment portion 52 decreases the value of M (namely, buffer size of buffer 12-1) from the current value to a predetermined value (for example, “1”), and may adjust the value of M. The same is true for the value of N.

### Second Modification Example

In the above-described third embodiment, made has been such explanation that the adjustment portion 52 adjusts the buffer size based on the transmission quantity. In contrast, in a second modification example of the third embodiment, the priority of the destination is adjusted based on the transmission quantity of the destination, and the buffer size is adjusted based on the adjusted priority. That is, the second modification example of the third embodiment corresponds to one mode obtained by combining the third embodiment and the first modification example of the second embodiment. Since a basic configuration of a frame translation device in the second modification example of the third embodiment is the same as that of the frame translation device in the third embodiment, FIG. 7 is referred to.

The adjustment portion 52 adjusts the buffer size of the buffer 12 by referring to the “priority information”, “buffer size information”, and “destination buffer mapping information”. The “destination buffer mapping information” and “buffer size information” are the same as those in the first modification example of the second embodiment. The “priority information” associates a priority with each of a plurality of ranges corresponding to magnitude of the transmission quantity. The “priority information” may associate a priority (low, medium, high) with each of three ranges corresponding to the magnitude of the transmission quantity (large, medium, small), for example. The “priority information” is, for example, a “priority table”. The “priority table” is stored in the storage portion 14.

For example, the adjustment portion 52 refers to the “priority information” to specify the priority according to the range including the first transmission quantity. Consequently, the priority associated with the first destination (first processing unit) is adjusted according to the first transmission quantity. Then, the adjustment portion 52 refers to the buffer size information and to specify the buffer size corresponding to the determined priority. Then, the adjustment portion 52 adjusts, to the specified buffer size, the buffer size of the buffer 12 associated with the first destination by the destination buffer mapping information.

Similarly, the adjustment portion 52 specifies the priority according to the range including the second transmission quantity. Then, the adjustment portion refers to the buffer size information to specify the buffer size corresponding to the specified priority. Next, the adjustment portion 52 adjusts the buffer size of the buffer 12 associated with the second destination by the destination buffer mapping information to the specified buffer size.

### Third Modification Example

In a third modification example of the third embodiment, as in the second modification example of the third embodiment, the priority of the destination is adjusted based on the transmission quantity of the destination, and the buffer size is adjusted based on the adjusted priority. That is, the third modification example of the third embodiment corresponds to one mode obtained by combining the third embodiment and the first modification example of the second embodiment.

In the second modification example of the third embodiment, the “priority information” associates a destination with a priority corresponding to the destination. In other words, the “priority information” associates a processing unit with a priority corresponding to the processing unit. Then, for example, when the first transmission quantity measured by the measurement portion 51 exceeds a predetermined threshold, the adjustment portion 52 reduces the priority of the first destination in the “priority information” from the current priority to a predetermined level (for example, one), may adjust the priority of the first destination. The same applies to the priority of the second destination.

Further, when the first transmission quantity measured by the measurement portion 51 is less than a second threshold, the adjustment portion 52 increases the priority of the first destination in the “priority information” from the current priority to a predetermined level (for example, one), and may adjust the priority of the first destination. The same applies to the priority of the second destination.

Then, the adjustment portion 52 may adjust the buffer sizes of the buffers 12-1, 12-2 based on the adjusted priority of the first destination and the second destination similarly to the adjustment portion 42 of the first modification example of the second embodiment or the second modification example of the second embodiment.

Through adjustment of the priority of the destination by the adjustment portion 52, if the priority of the destination with the large transmission quantity is increased and the buffer size of the buffer 12 associated with the destination having the large transmission quantity is increased, the number of frames collectively outputted from the buffer 12 can be increased. Therefore, one header part based on the second protocol is added to many frames outputted from the buffer 12 by the translation portion 13, so that the overhead of the header based on the second protocol can be reduced. Consequently, the transmission quantity to the destination in the second network 30 can be reduced, so the bandwidth used in the second network 30 can be reduced.

### Fourth Modification Example

In the above description, the buffer size or the priority of the destination is adjusted based on the transmission quantity of the frames based on the second protocol in the second network 30. In contrast, the buffer size or the priority of the destination may be adjusted based on the transmission quantity of the frames based on the first protocol in the first network 20.

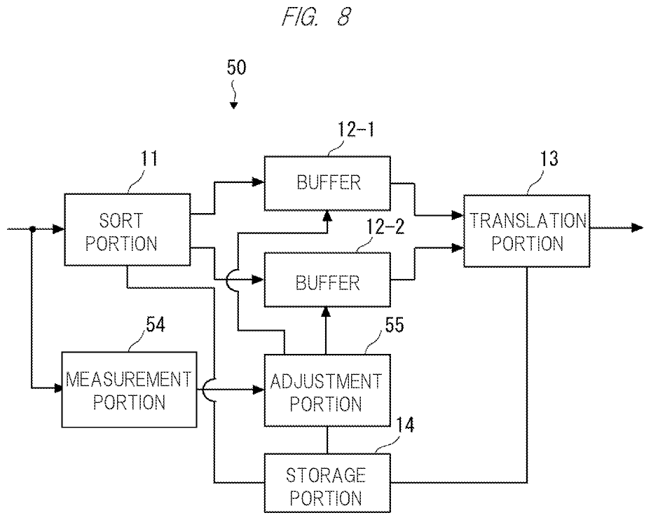

FIG. 8 is a block diagram showing one example of a frame translation device in a fourth modification example of the third embodiment. In FIG. 8, a frame translation device 50 has a sort portion 11, buffers 12-1, 12-2, a translation portion 13, a storage portion 14, a measurement portion 54, and an adjustment portion 55.

The measurement portion 54 measures a transmission quantity of the frames related to the first destination based on the first protocol in the first network 20, and a transmission quantity of the frames related to the second destination based on the first protocol in the first network 20. Hereinafter, the transmission quantity of the frames related to the first destination based on the first protocol in the first network 20 may simply be referred to as a “third transmission quantity”. Further, hereinafter, the transmission quantity related to the frame of the second destination based on the first protocol in the first network 20 may simply be referred to as a “fourth transmission quantity”.

The adjustment portion 55 adjusts the value of M (namely, buffer size of buffer 12-1) based on the third transmission quantity measured by the measurement portion 54. For example, the adjustment portion 55 may adjust the value of M based on the third transmission quantity measured by the measurement portion 54 and the “buffer size information”. The “buffer size information” associates a buffer size with each of a plurality of ranges corresponding to magnitude of the transmission quantity. The adjustment portion 55 specifies the buffer size associated with the range corresponding to the third transmission quantity measured by the measurement portion 54 in the “buffer size information”, and adjust the value of M to this buffer size. The “buffer size information” may associate different buffer sizes (3, 2, 1) with each of three ranges corresponding to the magnitude of the transmission quantity (large, medium, small), for example. The “buffer size information” is, for example, a “buffer size table”. The “buffer size table” is stored in the storage portion 14.

Similarly, the adjustment portion 55 adjusts the value of N (namely, buffer size of buffer 12-2) based on the fourth transmission quantity measured by the measurement portion 54. For example, the adjustment portion 55 may adjust the value of N to the buffer size according to the range including the fourth transmission quantity.

Here, the transmission quantity in the first network 20 to a certain destination can be an index of the transmission quantity to that destination in the second network 30. For this reason, the adjustment portion 55 increases the buffer size of the buffer 12 associated with the destination in the second network in which the transmission quantity of the first network 20 is large, and can increase the number of frames collectively outputted from the buffer 12. Consequently, one header part based on the second protocol is added to many frames outputted from the buffer 12 by the translation portion 13, so that the overhead of the header based on the second protocol can be reduced. Therefore, the transmission quantity to the destination in the second network 30 can be reduced, so the bandwidth used in the second network 30 can be reduced.

Incidentally, the adjustment portion 55 may set the initial value of M (namely, initial value of buffer size of buffer 12-1) based on the priority of the first destination, as in the first modification example of the third embodiment. Further, the adjustment portion 55 may set the initial value of N (namely, initial value of buffer size of buffer 12-2) based on the priority of the second destination.

Also, the adjustment portion 55 does not necessarily need to directly adjust the buffer sizes of the buffers 12-1, 12-2 based on the third transmission quantity and the fourth transmission quantity. For example, as in the second modification example of the third embodiment, the priorities of the first and second destinations are adjusted based on the third and fourth transmission quantities, and the buffer sizes of the buffers 12-1, 12-2 may be indirectly adjusted based on the adjusted priorities.

### Fifth Modification Example

Similar to the fourth modification example of the third embodiment, a fifth modification example of the third embodiment adjusts the buffer size or the destination of the priority based on the transmission quantity related to the frame that is based on the first protocol in the first network 20. A basic configuration of a frame translation device in a fifth modification example of the third embodiment is the same as that of the frame translation device in the fourth modification example of the third embodiment, so that FIG. 8 is referred to.

For example, when the third transmission quantity measured by the measurement portion 54 exceeds the first threshold, the adjustment portion 55 increases the value of M (namely, buffer size of buffer 12-1) from the current value to a predetermined value (for example, 1), and may adjust the value of M. The same is true for the value of N.

Further, when the third transmission quantity measured by the measurement portion 54 is less than the second threshold, the adjustment portion 52 decreases the value of M (namely, buffer size of buffer 12-1) from the current value to a predetermined value (for example, 1), and may adjust the value of M. The same is true for the value of N.

Incidentally, the adjustment portion 55 may set the initial value of M (namely, initial value of buffer size of buffer 12-1) based on the priority of the first destination, as in the first modification example of the third embodiment. Further, the adjustment portion 55 may set the initial value of N (namely, initial value of buffer size of buffer 12-2) based on the priority of the second destination.

Also, the adjustment portion 55 does not necessarily need to directly adjust the buffer sizes of the buffers 12-1, 12-2 based on the third transmission quantity and the fourth transmission quantity. For example, as in the second modification example of the third embodiment, the priorities of the first and second destinations are adjusted based on the third and fourth transmission quantities, and the buffer sizes of the buffers 12-1, 12-2 may be indirectly adjusted based on the adjusted priorities.

### Sixth Modification Example

In the third embodiment described above, the value of M (namely, buffer size of buffer 12-1) has been adjusted based on the first transmission quantity, and the value of N (for example, buffer size of buffer 12-2) has been adjusted based on the second transmission quantity. In a sixth modification example of the third embodiment, timing for adjusting the value of M is controlled based on the third transmission quantity, and timing for adjusting the value of M (namely, buffer of buffer 12-1) is controlled based on the fourth transmission quantity.

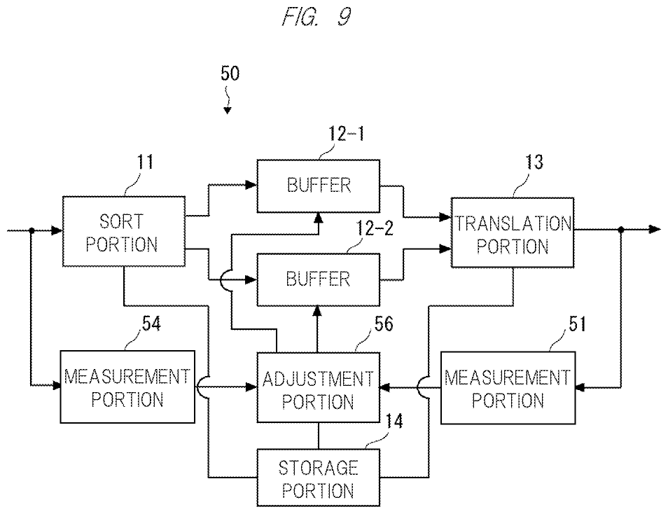

FIG. 9 is a block diagram showing one example of a frame translation device in a sixth modification example of the third embodiment. In FIG. 9, a frame translation device 50 includes a sort portion 11, buffers 12-1, 12-2, a translation portion 13, a storage portion 14, a measurement portion 51, a measurement portion 54, and an adjustment portion 56.

The adjustment portion 56 controls the timing for adjusting the value of M based on the third transmission quantity. Specifically, the adjustment portion 56 predicts a situation in which the frames are accumulated in the buffer 12-1 based on the third transmission quantity, and may control the timing for adjusting the value of M based on the predicted situation. For example, the adjustment portion 56 predicts timing when the number of frames accumulated in the buffer 12-1 is small based on the third transmission quantity, and may adjust the value of M (namely, buffer size of buffer 12-1) based on the first transmission quantity at that timing.

Also, the adjustment portion 56 controls the timing for adjusting the value of N based on the fourth transmission quantity. Specifically, the adjustment portion 56 predicts a situation in which the frames are accumulated in the buffer 12-2 based on the fourth transmission quantity, and may control the timing for adjusting the value of N based on the predicted situation. For example, the adjustment portion 56 predicts the timing when the number of frames accumulated in the buffer 12-2 is small based on the fourth transmission quantity, and may adjust the value of N (namely, buffer size of buffer 12-2) based on the second transmission quantity at that timing.

Here, as described above, if the value of the buffer size is adjusted at the timing when the frames are accumulated in the buffer 12, the accumulated frames may be lost. In contrast, the adjustment portion 56 predicts the timing when the number of frames accumulated in the buffer 12-1 is small based on the third transmission quantity, and adjust the value of M (namely, buffer size of buffer 12-1) based on the first transmission quantity at that timing. Similarly, the adjustment portion 56 predicts the timing when the number of frames accumulated in the buffer 12-2 is small based on the fourth transmission quantity, and adjusts the value of N (namely, buffer size of buffer 12-2) based on the second transmission quantity at that timing. Consequently, the adjustment portion 56 can adjust the values of the buffer sizes when the number of frames accumulated in the buffers 12 is small, so a risk of losing the accumulated frames can be reduced.

### Fourth Embodiment

A fourth embodiment relates to adjusting a buffer size based on a state of a vehicle or an environment in which the vehicle is placed.

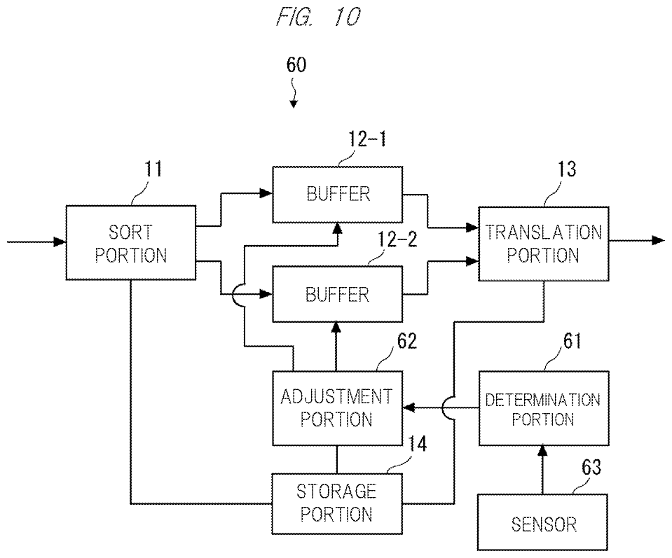

FIG. 10 is a block diagram showing one example of a frame translation device according to a fourth embodiment. In FIG. 10, a frame translation device 60 has a sort portion 11, buffers 12-1, 12-2, a translation portion 13, a storage portion 14, a determination portion 61, an adjustment portion 62, and a sensor 63. Incidentally, a basic configuration of a system in a fourth embodiment is the same as that of the system 1 shown in FIG. 1. That is, a system 1 in the fourth embodiment has a frame translation device 60 instead of the frame translation device 10. Also, in the fourth embodiment, it is assumed that the system 1 is installed in a vehicle. Here, in order to simplify the explanation, the number of buffers 12 included in the frame translation device 60 is assumed to be two, but the number is not limited to this. That is, the number of buffers 12 included in the frame translation device 60 may be three or more. Even in this case, three or more buffers 12 are associated with respectively different destinations.

In the fourth embodiment, the destination buffer mapping information associates the first destination with the buffer 12-1 and the second destination with the buffer 12-2. That is, in the fourth embodiment, it is assumed that the destination buffer mapping information is fixed.

The determination portion 61 determines a state of the system 1, that is, the vehicle, in which the frame translation device 60 is installed, based on sensing information of the sensor 63. The determined state of the vehicle is, for example, a current traveling state and a stopped state of the vehicle. For example, the sensor 63 may be a sensor that detects an axle rotation speed of the vehicle. In this case, the determination portion 61 can determine that the current state of the vehicle is a traveling state if the detected axle rotation speed is other than zero. Meanwhile, the determination portion 61 can determine that the current state of the vehicle is a stopped state if the detected axle rotation speed is zero. Incidentally, the determination portion 61 may predict the state of the vehicle in the near future instead of the current state of the vehicle or in addition to the current state of the vehicle.

The adjustment portion 62 adjusts the buffer size of at least one of the buffers 12-1, 12-2 based on the state of the vehicle determined by the determination portion 61. For example, the first destination is associated with a processing unit that handles data relating to a first operation performed on the vehicle, and the second destination is associated with a processing unit that handles data relating to a second operation performed on the vehicle. Then, the adjustment portion 62 adjusts the buffer size of the buffer 12-1 associated with the first destination based on the vehicle state determined by the determination portion 61 and the “buffer size information”. The “buffer size information” includes, for example, information on a plurality of buffer sizes respectively corresponding to a plurality of vehicle states for each buffer 12. The adjustment portion 62 adjusts the buffer size of the buffer 12-1 to the buffer size associated with the vehicle state determined by the determination portion 61 regarding the buffer 12-1 in the “buffer size information”. The “buffer size information” is, for example, a “buffer size table”. The “buffer size table” is stored in the storage portion 14.

Similarly, the adjustment portion 62 may adjust the buffer size of the buffer 12-2 associated with the second destination based on the vehicle state determined by the determination portion 61. For example, the adjustment portion 62 adjusts the buffer size of the buffer 12-2 associated with the second destination based on the vehicle state determined by the determination portion 61 and the “buffer size information”. Specifically, the adjustment portion 62 changes the buffer size of the buffer 12-2 to the buffer size associated with the vehicle state determined by the determination portion 61 regarding the buffer 12-2 in the “buffer size information”.

For example, a reclining operation is most likely to be performed while the vehicle is stopped, and less likely to be performed while the vehicle is traveling. For this reason, the number of frames sent to the destination (processing unit) that handles data relating to the reclining operation tends to increase while the vehicle is stopped, and tends to decrease while the vehicle is traveling. Here, it is assumed that the first destination associated with the buffer 12-1 is the destination that handles the data relating to the reclining operation. In this case, the “buffer size information” associates, for example, the stopped state with the buffer size “3” and the traveling state with the buffer size “1” for the buffer 12-1. By using this buffer size information, the adjustment portion 62 performs adjustment for increasing the buffer size of the buffer 12-1 when it is determined that the vehicle is in the stopped state. Meanwhile, the adjusting portion 62 performs adjustment for decreasing the buffer size of the buffer 12-1 when it is determined that the vehicle is in the traveling state. In this way, the number of frames collectively outputted from the buffers 12 can be increased by increasing the buffer sizes of the buffers 12 associated with the destination for which the increase in the transmission quantity is expected in the determined state. Consequently, one header part based on the second protocol is added to many frames outputted from the buffers 12 by the translation portion 13, so that the overhead of the header based on the second protocol can be reduced. Therefore, the transmission quantity to the destination in the second network 30 can be reduced, so the bandwidth used in the second network 30 can be reduced.

Here, the destination in which the frames are large in number changes depending on a type of the vehicle state. That is, the type of the vehicle state can be an index of the frame transmission quantity for each destination. Consequently, through the adjustment of the buffer size by the adjustment portion 62, the number of frames collectively outputted from the buffers 12 can be increased by increasing the buffer size of the buffer 12 associated with the destination for which the increase in the transmission quantity is expected in the determined state, and the number of frames collectively outputted from the buffers 12 can be increased. Thus, one header part based on the second protocol is added to many frames outputted from the buffers 12 by the translation portion 13, so that the overhead of the header based on the second protocol can be reduced. Therefore, the transmission quantity to the destination in the second network 30 can be reduced, so the bandwidth used in the second network 30 can be reduced.

### Modification Example

The frame translation device 60 of the fourth embodiment may be modified as follows.

A basic configuration of a frame translation device in a modification example of the fourth embodiment is the same as that of the frame translation device in the fourth embodiment, so that FIG. 10 will be referred to.

A determination portion 61 in a modification example of the fourth embodiment determines, based on the sensing information of the sensor 63, an environment in which the system 1, namely, the vehicle installing the frame translation device 60 is placed. The environment in which the vehicle to be determined is placed is, for example, rainy weather, non-rainy weather, and the like (for example, fine weather) that are current weather conditions. For example, the sensor 63 may be a sensor that detects on/off of wipers of the vehicle. In this case, when it is detected that the wipers are on, the determination portion 61 can determine that the current environment in which the vehicle is placed is rainy. Meanwhile, when it is detected that the wipers are off, the determination portion 61 can determine that the current environment in which the vehicle is placed is non-rainy. Incidentally the determination portion 61 may predict an environment in which the vehicle will be placed in the near future instead of the current environment in which the vehicle is placed or in addition to the current environment in which the vehicle is placed.

The adjustment portion 62 adjusts the buffer size of at least one of the buffers 12-1, 12-2 based on the environment in which the vehicle determined by the determination portion 61 is placed. For example, the first destination is associated with a processing unit handling data relating to a third operation performed on the vehicle, and the second destination is associated with a processing unit handling data relating to a fourth operation performed on the vehicle. Then, the adjustment portion 62 adjusts the buffer size of the buffer 12-1 associated with the first destination based on the environment in which the vehicle determined by the determination portion 61 is placed and the “buffer size information”. The “buffer size information” includes, for example, information on a plurality of buffer sizes corresponding to a plurality of vehicle environments for each buffer 12. The adjustment portion 62 adjusts the buffer size of the buffer 12-1 to the buffer size associated with the vehicle environment determined by the determination portion 61 regarding the buffer 12-1 in the “buffer size information”. The “buffer size information” is, for example, a “buffer size table”. The “buffer size table” is stored in the storage portion 14.

Similarly, the adjustment unit 62 adjusts the buffer size of the buffer 12-2 associated with the second destination based on the environment in which the vehicle determined by the determination portion 61 is placed. For example, the adjustment portion 62 adjusts the buffer size of the buffer 12-2 associated with the second destination based on the vehicle state determined by the determination portion 61 and the “buffer size information”.

For example, a wiper operation is more likely to be performed in a wet environment, and less likely to be performed in a non-wet environment. For this reason, the number of frames to the destination (processing unit), which handles data relating to the wiper operation, tends to be more in the rainy environment, and less in the non-rainy environment. Here, it is assumed that the first destination associated with the buffer 12-1 is the destination that handles data related to the wiper operation. In this case, the “buffer size information” associates, for example, a buffer size of “3” with the rainy environment and a buffer size of “1” with the non-rainy environment for the buffer 12-1. By using this buffer size information, the adjustment portion 62 performs adjustment for increasing the buffer size of the buffer 12-1 when it is determined that the environment is rainy. Meanwhile, the adjustment portion 62 performs adjustment for reducing the buffer size of the buffer 12-1 when it is determined that the environment is non-rainy. In this way, the number of frames collectively outputted from the buffer 12 can be increased by increasing the buffer sizes of the buffers 12 associated with the destination expecting that the transmission quantity is large in the determined environment in which the determined vehicle is placed, and the number of frames collectively outputted from the buffer 12 can be increased. Consequently, one header part based on the second protocol is added to many frames outputted from the buffers 12 by the translation portion 13, so that the overhead of the header based on the second protocol can be reduced. Therefore, the transmission quantity to the destination in the second network 30 can be reduced, so that the bandwidth used in the second network 30 can be reduced.

Here, the destination in which the number of frames is large changes depending on a type of environment in which the vehicle is placed. That is, the type of environment in which the vehicle is placed can serve as an indicator of the frame transmission quantity for each destination. For this reason, through the adjustment of the buffer size by the adjustment portion 62, the buffer sizes of the buffers 12 associated with the destination expecting that the transmission quantity is large in the environment in which the determined vehicle is placed is increased, and the number of frames collectively outputted from the buffers 12 can be increased. Consequently, one header part based on the second protocol is added to many frames outputted from the buffers 12 by the translation portion 13, so that the overhead of the header based on the second protocol can be reduced. Therefore, the transmission quantity to the destination in the second network 30 can be reduced, so that the bandwidth used in the second network 30 can be reduced.

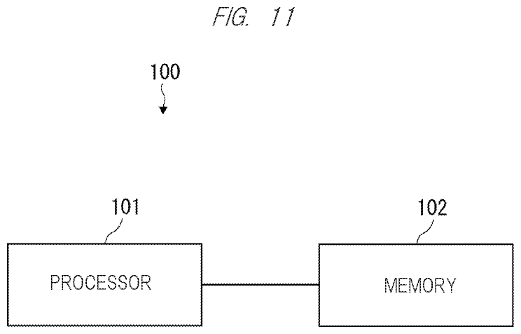

Each of the frame translation devices 10, 40, 50, 60 of the first to fourth embodiments can have a configuration shown in FIG. 11. FIG. 11 is a diagram showing a configuration example of a frame translation device. A frame translation device 100 in FIG. 11 has a processor 101 and a memory 102. The processor 101 may be, for example, a microprocessor, an Micro Processing Unit (MPU), or a Central Processing Unit (CPU). The processor 101 may include a plurality of processors. The memory 102 is configured by a combination of a volatile memory and a non-volatile memory. The memory 102 may include a storage remotely located from the processor 101. In this case, the processor 101 may access the memory 102 via an Input/Output (I/O) interface (not shown). The sort portion 11, the translation portion 13, the adjustment portions 41, 42, 43, 52, 53, 55, 62, 64, and the measurement portions 51, 54, and the determination portions 61, 63 of the frame translation devices 10, 40, 50, 60 of the first to fourth embodiments may be realized by the processor 101 reading and executing a program(s) stored in the memory 102. That is, the frame translation devices 10, 40, 50, 60 of the first to fourth embodiments can be realized by software. The buffers 12-1, 12-2 may be realized by the memory 102. The program can be stored by using various types of non-transitory computer readable media, and be supplied to the frame translation devices 10, 40, 50, 60. Examples of the non-transitory computer-readable media include magnetic recording media (for example, floppy disks, magnetic tapes, hard disk drives), magneto-optical recording media (for example, magneto-optical disks). Furthermore, examples of the non-transitory computer readable media include Compact Disc (CD)-Read Only Memory (ROM), CD-R, and CD-R/W. Further examples of the non-transitory computer-readable media include a semiconductor memory. The semiconductor memory includes, for example, a mask ROM, a Programmable ROM (PROM), an Erasable PROM (EPROM), a flash ROM, and a Random Access Memory (RAM). In addition, the program may be supplied to the frame translation devices 10, 40, 50, 60 by various types of transitory computer readable media. Examples of the transitory computer-readable media include electrical signals, optical signals, and electromagnetic waves. The transitory computer-readable media can supply the programs to the frame translation devices 10, 40, 50, 60 via wired communication channels such as electrical wires and optical fibers, or wireless communication channels.

However, the frame translation devices 10, 40, 50, 60 described in the first to fourth embodiments can also be realized by hardware (circuits). That is, the sort portion 11, the translation portion 13, the adjustment portions 41, 42, 43, 52, 53, 55, 62, 64, the measurement portions 51, 54, and the determination portions 61, 63 of the frame translation devices 10, 40, 50, 60 of the first to fourth embodiments may be realized by circuits.

The invention made by the present inventor(s) has been specifically described above based on the embodiments, but the present invention is not limited to the embodiments already described and, needless to say, can be variously modified without departing from the scope of the invention.

What is claimed is:

1. A program for causing a frame translation device disposed between a first network based on a first protocol and a second network based on a second protocol to perform a processing, the processing comprising:
causing a first buffer to hold sorted frames and, when a number of held frames reaches M, to collectively output the M frames;
causing the second buffer to hold sorted frames and, when a number of held frames reaches N, to collectively output the N frames;
based on a correspondence relationship between first and second destinations of the frame based on the first protocol and the first and second buffers, sorting frames based on the first protocol into the first buffer and the second buffer;
adding one header, which is based on the second protocol and includes a destination associated with the first buffer in the correspondence relationship, to all of the M frames outputted from the first buffer, thereby forming a frame based on the second protocol and outputting the frame based on the second protocol to the second network; and
adding one header, which is based on the second protocol and includes a destination associated with the first buffer in the correspondence relationship, to all of the N frames outputted from the second buffer, thereby forming a frame based on the second protocol and outputting the frame based on the second protocol to the second network,
wherein a value of the M and a value of the N are each an integer of 1 or more, and
wherein at least one of the value of the M and the value of the N is an integer of 2 or more.

2. The program according to claim 1,
wherein the value of the M is less than the value of the N, and
wherein the processing further includes adjusting the correspondence relationship between the first and second destinations and the first and second buffers.

3. The program according to claim 1,
wherein in the correspondence relationship, the first destination is associated with the first buffer, the second destination is associated with the second buffer,
wherein the processing further includes:
adjusting the value of the M based on a priority of the first destination; and
adjusting the value of the N based on a priority of the second destination.

4. The program according to claim 1,
wherein in the correspondence relationship, the first destination is associated with the first buffer, the second destination is associated with the second buffer, and
wherein the processing further includes adjusting the value of the M and the value of the N based on a priority of the first destination and a priority of the second destination.

5. The program according to claim 1,
wherein in the correspondence relationship, the first destination is associated with the first buffer, the second destination is associated with the second buffer, and
wherein the processing further includes:
measuring a first transmission quantity relating to the frame of the first destination based on the second protocol in the second network and a second transmission quantity relating to the frame of the second destination based on the second protocol in the second network; and
adjusting the value of the M based on the first transmission quantity and adjusting the value of the N based on the second transmission quantity.

6. The program according to claim 1,
wherein in the correspondence relationship, the first destination is associated with the first buffer, and the second destination is associated with the second buffer, and
wherein the processing further includes:
measuring a third transmission quantity relating to the frame of the first destination based on the first protocol in the first network and a fourth transmission quantity relating to the frame of the second destination based on the first protocol in the first network;
adjusting the value of the M based on the third transmission quantity; and
adjusting the value of the N based on the fourth transmission quantity.

7. The program according to claim 3,
wherein the processing further includes measuring a first transmission quantity relating to the frame of the first destination based on the second protocol in the second network and a second transmission quantity relating to the frame of the second destination based on the second protocol in the second network,
wherein adjusting the value of the M includes adjusting a priority of the first destination based on the first transmission quantity, and
wherein adjusting the value of the N includes adjusting a priority of the second destination based on the second transmission quantity.

8. The program according to claim 4,
wherein the processing further includes measuring a first transmission quantity relating to the frame of the first destination based on the second protocol in the second network and a second transmission quantity relating to the frame of 35 the second destination based on the second protocol in the second network, and
wherein adjusting the value of the M and the value of the N includes adjusting the priority of the first destination and the priority of the second destination based on the first transmission quantity and the second transmission quantity.

9. The program according to claim 1,
wherein the first network, the second network, and the frame translation device are installed in a vehicle,
wherein in the correspondence relationship, the first destination is associated with the first buffer, and the second destination is associated with the second buffer, and
wherein the processing further includes:
determining a state of the vehicle; and
adjusting at least one of the value of the M and the value of the N based on the determined state.

10. The program according to claim 9,
wherein the first destination is associated with a first operation performed on the vehicle,
wherein the second destination is associated with a second operation performed on the vehicle, and
wherein the adjusting includes:
when it is determined that the state of the vehicle is a first state, such adjustment as to increase the value of the M; and
when it is determined that the state of the vehicle is a second state, such adjustment as to decrease the value of the M.

11. The program according to claim 1,
wherein the first network, the second network, and the frame translation device are installed in a vehicle,
wherein in the correspondence relationship, the first destination is associated with the first buffer, and the second destination is associated with the second buffer, and
wherein the processing further includes:
determining an environment in which the vehicle is placed; and
adjusting at least one of the value of the M and the value of the N based on the determined environment.

12. The program according to claim 11,
wherein the first destination is associated with a third operation performed on the vehicle,
wherein the second destination is associated with a fourth operation performed on the vehicle, and
wherein the adjusting includes:
when it is determined that the environment in which the vehicle is placed is a first environment, such adjustment as to increase the value of the M; and
when it is determined that the environment in which the vehicle is placed is a second environment, such adjustment as to decrease the value of the M.

13. A frame translation device arranged between a first network based on a first protocol and a second network based on a second protocol, the frame translation device comprising:
a first buffer holding sorted frames and, when a number of held frames reaches M, collectively outputting the M frames;
a second buffer holding sorted frames and, when a number of held frames reaches N, collectively outputting the N frames;
a sort portion sorting, based on a correspondence relationship between first and second destinations of the frames based on the first protocol and the first and second buffers, the frames based on the first protocol into the first and second buffers; and
a translation portion adding one header, which is based on the second protocol and includes the destination associated with the first buffer in the correspondence relationship, to all of the M frames outputted from the first buffer, thereby forming the frames based on the second protocol, outputting the frames based on the second protocol to the second network, and the translation portion adding one header, which is based on the second protocol and includes the destination associated with the first buffer in the correspondence relationship, to all of the N frames outputted from the first buffer, thereby forming the frames based on the second protocol and outputting the frames based on the second protocol to the second network,
wherein a value of the M and a value of the N are each an integer of 1 or more, and
wherein at least one of the value of the M and the value of the N is an integer of 2 or more.

14. The frame translation device according to claim 13,
wherein the value of the M is smaller than the value of the N, and
wherein the translation device further includes an adjustment portion adjusting the correspondence relationship between the first and second destinations and the first and second buffers.

15. The frame translation device according to claim 13,
wherein in the correspondence relationship, the first destination is associated with the first buffer, and the second destination is associated with the second buffer, and
wherein the frame translation device further includes an adjustment portion adjusting the value of the M based on a priority of the first destination and the value of the N based on a priority of the second destination.

16. The frame translation device according to claim 13,
wherein in the correspondence relationship, the first destination is associated with the first buffer, and the second destination is associated with the second buffer, and
wherein the frame translation device further includes an adjustment portion adjusting the value of the M and the value of the N based on a priority of the first destination and a priority of the second destination.

17. A method by a frame translation device arranged between a first network based on a first protocol and a second network based on a second protocol, the method comprising:
sorting frames based on the first protocol into the first buffer and the second buffer based on a correspondence relationship between first and second destinations of frames based on the first protocol and first and second buffers;
holding the sorted frames by the first buffer and, when a number of held frames reaches M, collectively outputting the M frames;
holding the sorted frames by the second buffer and, when a number of held frames reaches N, collectively outputting the N frames;
adding one header, which is based on the second protocol and includes the destination associated with the first buffer in the correspondence relationship, to all of the M frames outputted from the first buffer, thereby forming the frames based on the second protocol and outputting the frames based on the second protocol to the second network; and
adding one header, which is based on the second protocol and includes the destination associated with the first buffer in the correspondence relationship, to all of the N frames outputted from the second buffer, thereby forming the frames based on the second protocol and outputting the frames based on the second protocol to the second network,
wherein a value of the M and a value of the N are each an integer of 1 or more, and
wherein at least one of the value of the M and the value of the N is an integer of 2 or more.

18. The method according to claim 17,
wherein the value of the M is smaller than the value of the N, and
wherein the method further includes adjusting the correspondence relationship between the first and second destinations and the first and second buffers.

19. The method according to claim 17,
wherein in the correspondence relationship, the first destination is associated with the first buffer, and the second destination is associated with the second buffer, and
wherein the method further includes adjusting the value of the M based on a priority of the first destination and adjusting the value of the N based on a priority of the second destination.

20. The method according to claim 17,
wherein in the correspondence relationship, the first destination is associated with the first buffer, and the second destination is associated with the second buffer, and
wherein the method further includes adjusting the value of M the and the value of the N based on a priority of the first destination and a priority of the second destination.
